(19) United States
(12) Patent Application Publication
(10) Pub. No.: US 2023/0386699 A1
(43) Pub. Date: Nov. 30, 2023

(54) DIELECTRIC COMPOSITION AND ELECTRONIC DEVICE

(71) Applicant: TDK CORPORATION, Tokyo (JP)

(72) Inventors: Toshihiro IGUCHI, Tokyo (JP); Kenichiro MASUDA, Tokyo (JP)

(73) Assignee: TDK CORPORATION, Tokyo (JP)

(21) Appl. No.: 18/308,294

(22) Filed: Apr. 27, 2023

(30) Foreign Application Priority Data
May 31, 2022 (JP) 2022-088934

(51) Int. Cl. H01B 3/10

(52) U.S. Cl. CPC H01B 3/10

(57) ABSTRACT

A dielectric composition includes main phases having a tungsten bronze structure and grain boundaries existing between the main phases. At least one or more rare earth elements selected from La, Ce, Pr, Nd, Sm, Eu, Gd, Tb, and Dy is RE. A concentration ratio of RE in central portions of the main phases to RE in peripheral portions of the main phases is 0.2 or less.

The present application claims a priority based on Japanese Patent Application No. 2022-088934 filed on May 31, 2022 and incorporates it into the present specification by reference to that disclosure in its entirety.

### BACKGROUND OF THE INVENTION

The present invention relates to a dielectric composition and an electronic device including dielectric layers composed of the dielectric composition.

Electronic circuits or power supply circuits incorporated in electronic equipment are equipped with a large number of electronic devices such as multilayer ceramic capacitors for utilizing dielectric characteristics of dielectrics. As materials constituting dielectrics of such electronic devices (dielectric materials), barium titanate based dielectric compositions are widely used.

As a dielectric composition other than the barium titanate based dielectric compositions, Japanese Patent Application Laid-Open No. H03-274607 discloses a dielectric composition having a tungsten bronze structure, and dielectric compositions having a tungsten bronze structure and exhibiting a higher relative permittivity are demanded.

### BRIEF SUMMARY OF THE INVENTION

The present invention has been achieved under such circumstances. It is an object of the invention to provide a dielectric composition exhibiting a high relative permittivity and an electronic device including dielectric layers composed of the dielectric composition.

To achieve the above object, a dielectric composition according to the first aspect of the present invention comprises:
main phases having a tungsten bronze structure; and
grain boundaries existing between the main phases, wherein
at least one or more rare earth elements selected from La, Ce, Pr, Nd, Sm, Eu, Gd, Tb, and Dy is RE, and
a concentration ratio of RE in central portions of the main phases to RE in peripheral portions of the main phases is 0.2 or less.

A dielectric composition according to the second aspect of the present invention comprises:
main phases with a tungsten bronze structure; and
grain boundaries existing between the main phases, wherein
at least one or more rare earth elements selected from La, Ce, Pr, Nd, Sm, Eu, Gd, Tb, and Dy is RE, and
a concentration ratio of RE in central portions of the main phases to RE in the grain boundaries is 0.18 or less.

The dielectric compositions according to the first aspect and the second aspect of the present invention can exhibit a high relative permittivity.

The dielectric compositions according to the first aspect and the second aspect of the present invention can also exhibit a high strength.

Preferably, the main phases have an average particle size of 1.5 μm or less.

As a result, a higher relative permittivity can be exhibited, and a higher strength can be exhibited.

A composition of the main phases may be represented by a formula of AₐB_{b}D₄O₁₅₊α, in which
A includes at least Ba and RE,
B includes at least Zr,
D includes at least Nb,
a is 3.05 or more, and
b is 1.01 or more.

As a result, the dielectric compositions according to the present invention can exhibit a higher resistivity.

Preferably, an RE content of the dielectric composition is 0.05 to 0.4 parts by mol, provided that a D content of the dielectric composition is 4 parts by mol.

As a result, the dielectric compositions according to the present invention can exhibit a higher relative permittivity. Moreover, when the RE content is within the above-mentioned range, a higher strength can be exhibited compared to when the RE content is below the above-mentioned range.

Preferably, the dielectric compositions further comprise a segregation phase including Ba and Nb.

As a result, the dielectric compositions according to the present invention can exhibit a higher relative permittivity.

An electronic device according to the present invention comprises dielectric layers composed of the above-mentioned dielectric composition.

### BRIEF DESCRIPTION OF THE DRAWING(S)

FIG. 1 is a schematic cross-sectional view of a multilayer ceramic capacitor according to an embodiment of the present invention;

FIG. 2 is a schematic cross-sectional view of a dielectric composition constituting dielectric layers shown in FIG. 1; and

FIG. 3 is an enlarged view of Part III in FIG. 2.

### DETAILED DESCRIPTION OF THE INVENTION

Hereinafter, the present invention is described based on specific embodiments.

### First Embodiment

### Multilayer Ceramic Capacitor

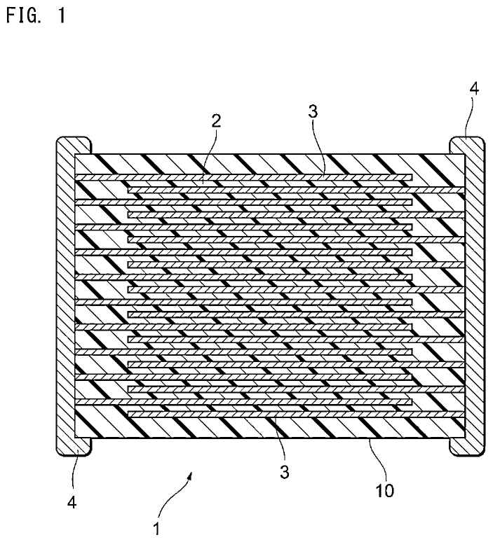

FIG. 1 shows a multilayer ceramic capacitor 1 as an example of an electronic device according to the present embodiment. The multilayer ceramic capacitor 1 includes an element body 10 consisting of dielectric layers 2 and internal electrode layers 3 alternately laminated. A pair of external electrodes 4 electrically connected to the internal electrode layers 3 alternately arranged inside the element body 10 is formed at both ends of the element body 10. The shape of the element body 10 is not limited, but is normally rectangular parallelepiped. The dimensions of the element body 10 are not limited either and are determined appropriately according to the application.

The dielectric layers 2 are composed of a dielectric composition according to the present embodiment described below. The thickness per layer (interlayer thickness) of the dielectric layers 2 is not limited and can be freely determined according to desired characteristics, applications, and the like. Normally, the interlayer thickness is preferably 100 μm or less and is more preferably 30 μm or less. The lamination number of dielectric layers 2 is not limited, but is preferably, for example, 20 or more in the present embodiment.

In the present embodiment, the internal electrode layers 3 are laminated so that their end surfaces are alternately exposed to the surfaces of two opposite ends of the element body 10.

The main component of the conductive material contained in the internal electrode layers 3 is a metal. The metal is not limited and is a known conductive material as a metal, such as Pd, Pd based alloy, Pt, Pt based alloy, Ni, Ni based alloy, Cu, and Cu based alloy. The metal may contain various fine components, such as P, in an amount of about 0.1 mass % or less. The internal electrode layers 3 may be formed using a commercially available electrode paste. The thickness of the internal electrode layers 3 is appropriately determined depending on the application.

The conductive material contained in the external electrodes 4 is not limited and is a known conductive material, such as Ni, Cu, Sn, Ag, Pd, Pt, Au, their alloy, and conductive resin. The thickness of the external electrodes 4 is appropriately determined depending on the application.

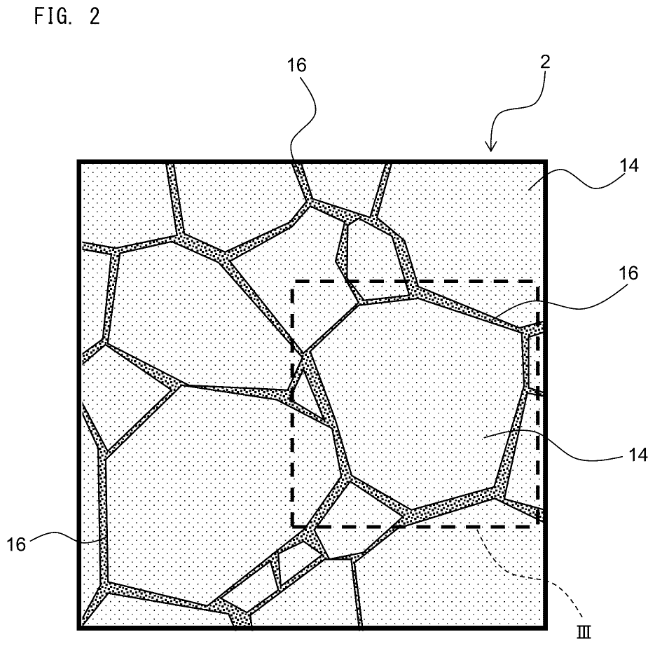

As shown in FIG. 2, the dielectric composition according to the present embodiment includes main phases 14 and grain boundaries 16 existing between the main phases 14. The grain boundaries 16 contain components or the like diffused from the main phases 14. In the present embodiment, the main phases 14 are main phases 14 after sintering.

The main phases 14 are composed of a composite oxide having a tungsten bronze structure. In the present embodiment, the composite oxide is contained in 80 mass % or more, preferably 90 mass % or more, in 100 mass % of the dielectric composition.

The average particle size of the main phases 14 is preferably 1.5 μm or less and is more preferably within the range of 0.3 to 1.0 In the present embodiment, the particle sizes of the main phases 14 can be measured as, for example, circle area equivalent diameters. The circle area equivalent diameter signifies a diameter of a circle having the same area as this shape.

Preferably, the particle sizes of the main phases 14 have a D90 of 3 μm or less. Here, a D90 is a particle size of a particle with a cumulative frequency of 90% counting from the smaller particle sizes.

Elements other than oxygen contained in a composite oxide having a tungsten bronze structure are divided into three element groups (“A”, “B”, and “D”) substantially based on valence, and the composite oxide is represented by a formula of AₐB_{b}D₄O₁₅₊α.

“A” includes Ba and RE mentioned below. “B” is a tetravalent element and includes Zr. “D” is a pentavalent element and includes Nb. In addition, “a” in the above-mentioned formula indicates an atomic number ratio of “A” when the element constituting “D” contains four atoms in the formula, and “b” in the above-mentioned formula indicates an atomic number ratio of “B” when the element constituting “D” contains four atoms in the formula.

In the present embodiment, “a” is 3.05 or more and is preferably 3.10 or more. The upper limit of “a” is, for example, preferably 3.50 or less and is more preferably 3.30 or less.

In the present embodiment, “b” is 1.01 or more and is preferably 1.05 or more. The upper limit of “b” is, for example, preferably 1.50 or less and is more preferably 1.30 or less.

Thus, the above-mentioned composite oxide can be said to be a composite oxide whose stoichiometric composition is represented by a formula of A₃B₁D₄O₁₅, in which “A” and “B” are excessively contained in a predetermined proportion with respect to “D”.

In the composite oxide, the amount of oxygen (O) may change depending on the composition proportion of “A”, “B”, and “D”, oxygen defects, and the like. Thus, in the present embodiment, a stoichiometric ratio in the composite oxide represented by the formula of A₃B₁D₄O₁₅ is used as a reference, and a deviation amount of oxygen from the stoichiometric ratio is represented by “a”. The range of “a” is not limited and is, for example, about −1 or more and 1 or less.

In the present embodiment, “A” includes at least Ba and RE mentioned below, but may include a divalent element 1A in addition to Ba. Preferably, “1A” includes one or more selected from the group consisting of Mg, Ca, and Sr.

From the viewpoint of obtaining a high relative permittivity, when the total number of atoms constituting “A” is 1, the ratio of the number of Mg atoms is preferably 0.20 or less and is more preferably 0.10 or less.

“B” includes at least Zr, but may include a tetravalent element 1B in addition to Zr. Preferably, “1B” includes one or more selected from the group consisting of Ti and Hf.

In the present embodiment, from the viewpoint of obtaining a high resistivity, when the total number of atoms constituting “B” is 1, the ratio of the number of Ti atoms is preferably 0.25 or less, more preferably 0.125 or less, and still more preferably substantially free of Ti. Here, “substantially free of Ti” means that Ti may be contained as long as its amount is due to unavoidable impurities.

“D” includes at least Nb, but may include a pentavalent element 1D in addition to Nb. Preferably, “1D” includes Ta.

When the total number of atoms constituting “A” is 1, the ratio of the number of atoms of the divalent element 1A other than Mg, Ca, and Sr is preferably 0.10 or less. When the total number of atoms constituting “B” is 1, the ratio of the number of atoms of the tetravalent element 1B other than Ti and Hf is preferably 0.10 or less. When the total number of atoms constituting “D” is 1, the ratio of the number of atoms of the pentavalent element 1D other than Ta is preferably 0.10 or less.

As described above, the dielectric composition according to the present embodiment includes the main phases 14 and the grain boundaries 16 existing between the main phases 14. The main phases 14 include a predetermined rare earth element represented by “RE”. Also, the grain boundaries 16 include RE.

In the present embodiment, RE is a rare earth element whose trivalent hexacoordinate ionic radius with a valence of 3 and a coordination number of 6 is equal to or larger than the trivalent hexacoordinate ionic radius of Dy. That is, RE is a rare earth element having a comparatively large ionic radius and a trivalent hexacoordinate ionic radius close to the divalent hexacoordinate ionic radius (1.35 Å) of Ba. Thus, RE easily replaces the Ba²⁺ site of the tungsten bronze structure constituting the main phases 14. RE satisfying these conditions are La, Ce, Pr, Nd, Sm, Eu, Gd, Tb, and Dy. In the present embodiment, RE is preferably at least one or more selected from La, Ce, Pr, Nd, Sm, Eu, Gd, Tb, and Dy and is more preferably Sm.

The trivalent hexacoordinate ionic radius of La is 1.032 Å. The trivalent hexacoordinate ionic radius of Ce is 1.01 Å. The trivalent hexacoordinate ionic radius of Pr is 0.99 Å. The trivalent hexacoordinate ionic radius of Nd is 0.983 Å. The trivalent hexacoordinate ionic radius of Sm is 0.958 Å. The trivalent hexacoordinate ionic radius of Eu is 0.947 Å. The trivalent hexacoordinate ionic radius of Gd is 0.938 Å. The trivalent hexacoordinate ionic radius of Tb is 0.923 Å. The trivalent hexacoordinate ionic radius of Dy is 0.912 Å.

In the dielectric composition according to the present embodiment, the larger the ionic radius of RE to be contained is, the smaller the particle sizes of the main phases 14 tend to be.

When the composition of the main phases 14 is represented by a formula of AₐB_{b}D₄O₁₅₊α, an RE content of the dielectric composition is preferably 0.05 to 0.4 parts by mol and is more preferably 0.06 to 0.35 parts by mol, provided that a D content of the dielectric composition is 4 parts by mol.

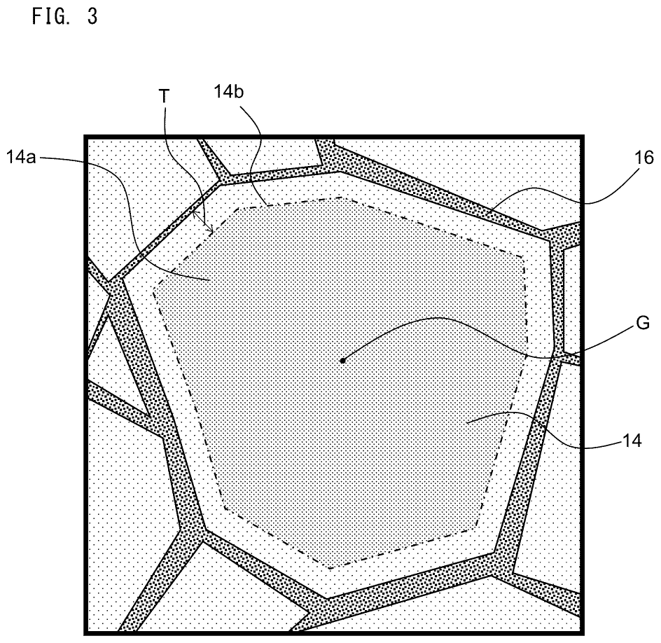

FIG. 3 is an enlarged view of Part III of FIG. 2. In the dielectric composition according to the present embodiment, a concentration of RE in a peripheral portion 14b of the main phase 14 shown in FIG. 3 (peripheral-portion RE concentration) is higher than a concentration of RE in a central portion 14a of the main phase 14 (central-portion RE concentration).

The central portion 14a of the main phase 14 is not limited, but is, for example, a position of the center of gravity G calculated from the particle size of the main phase 14.

The peripheral portion 14b of the main phase 14 is not limited, but is, for example, a position away from a boundary portion between the main phase 14 and the grain boundary 16 (an outer circumference of the main phase 14) toward the inner side of the main phase 14 by a thickness T. Thus, as shown in FIG. 3, the peripheral portion 14b can be said to be any position on the curved line indicated by the dashed-dotted line. Preferably, T is 100 nm.

In the present embodiment, “central-portion RE concentration/peripheral-portion RE concentration” is preferably 0.2 or less and is more preferably 0.04 or less.

In the dielectric composition according to the present embodiment, a concentration of RE in the grain boundary 16 of the main phase 14 shown in FIG. 3 (grain-boundary RE concentration) is higher than a central-portion RE concentration.

“central-portion RE concentration/grain-boundary RE concentration” is preferably 0.18 or less and is more preferably 0.03 or less.

In addition to the elements constituting the above-mentioned composite oxide or Ba, Sr, and Si, the dielectric composition according to the present embodiment may include other components, such as Al, V, alkali metals, and Mn. The amount of other components is preferably 20 mass % or less, more preferably 10 mass % or less, in 100 mass % of the dielectric composition. In particular, from the viewpoint of improving the resistivity, the Fe₂O₃ content is preferably 0.1 mass % or less in total in 100 mass % of the dielectric composition.

The method of observing the structure of the dielectric composition is not limited. For example, a cross section of the dielectric composition can be observed with a reflected electron image of a scanning electron microscope (SEM) or a HAADF image of a scanning transmitted electron microscope (STEM). In this case, the main phases 14 are often recognized as bright parts of contrast. This is because the main phases 14 are often denser than the grain boundaries 16 or Ba—Nb based segregation phases mentioned below. Thus, the grain boundaries 16 or Ba—Nb based segregation phases mentioned below, which are often less dense than the main phases 14, are often recognized as dark parts of contrast. The area of field of view to be photographed, namely, “predetermined field of view” is not limited and is, for example, a square of about 1 to 50 μm.

### Method of Manufacturing Multilayer Ceramic Capacitor

Next, an example of a method of manufacturing a multilayer ceramic capacitor 1 shown in FIG. 1 is described below.

The multilayer ceramic capacitor 1 according to the present embodiment can be manufactured by substantially the same method as conventional multilayer ceramic capacitors. As a conventional method, for example, there is a method of manufacturing green chips using a paste containing raw materials of a dielectric composition and firing them so as to manufacture a multilayer ceramic capacitor. Hereinafter, a manufacturing method is specifically described.

First, a starting raw material for a dielectric composition is prepared. As the starting raw material, a composite oxide constituting the main phases 14 of the above-mentioned dielectric composition can be employed. Moreover, it is possible to employ an oxide of each metal contained in the composite oxide. Moreover, it is possible to employ various compounds to be components constituting the composite oxide by firing. Examples of the various compounds include carbonate, oxalate, nitrate, hydroxide, and metal organic compound.

As a starting raw material for RE, an oxide containing RE or various compounds to be an oxide of RE by firing are prepared. In the present embodiment, preferably, the starting raw materials for the main phases 14 and RE are powder.

Among the prepared starting raw materials, the raw material for the main phases 14 are weighed at a predetermined ratio and thereafter mixed in a wet manner for a predetermined time using a ball mill and the like. After drying this mixed powder, a heat treatment is performed in the atmosphere at a temperature of 700 to 1300° C. to obtain a calcined powder of the composite oxide constituting the main phases 14.

The starting raw material for RE is finely pulverized to obtain a pulverized product of RE. A mixture of the composite oxide constituting the main phases 14 and RE is obtained by dispersing the calcined powder of the composite oxide constituting the main phases 14 and the pulverized product of RE under high pressure together with a dispersion medium and drying them so as to uniformly disperse the pulverized product of RE around the composite oxide constituting the main phases 14. The dispersion medium is not limited and is, for example, water.

Since the pulverized product of RE is uniformly dispersed around the composite oxide constituting the main phases 14 in such a manner, the peripheral-portion RE concentration and the grain-boundary RE concentration easily become sufficiently higher than the central-portion RE concentration.

Next, a paste for producing green chips is prepared. The obtained mixture of the composite oxide constituting the main phases 14 and RE, a binder, and a solvent are kneaded and turned into a paint to prepare a dielectric layer paste. The binder and the solvent are known ones. If necessary, the dielectric layer paste may also contain additives, such as plasticizers and dispersants.

An internal electrode layer paste is obtained by kneading a raw material of the above-mentioned conductive material, a binder, and a solvent. The binder and the solvent are known ones. If necessary, the internal electrode layer paste may contain additives, such as inhibitors and plasticizers.

An external electrode layer paste can be prepared similarly to the internal electrode layer paste.

Green sheets and an internal electrode pattern are formed using the obtained pastes, and these are laminated to obtain a green chip.

If necessary, the obtained green chip is subjected to a binder removal treatment. Conditions for the binder removal treatment are known ones. For example, the holding temperature is preferably 200 to 350° C.

After the binder removal treatment, the green chip is fired to obtain an element body. In the present embodiment, the firing can be performed in the air. Moreover, a firing (reduction firing) can also be performed in a reducing atmosphere. Other conditions for the firing are known ones. For example, the holding temperature is preferably 1200 to 1450° C.

After the firing, if necessary, the obtained element body is subjected to a reoxidation treatment (annealing). Conditions for the annealing are known ones. For example, preferably, the oxygen partial pressure during the annealing is higher than the oxygen partial pressure during the firing, and the holding temperature is 1150° C. or less.

The dielectric composition constituting the dielectric layers 2 of the element body 10 obtained as described above is the above-mentioned dielectric composition. The end surfaces of the element body 10 are polished, and the external electrode paste is applied thereto and baked to form the external electrodes 4. Then, if necessary, a coating layer is formed on the surfaces of the external electrodes 4 by plating or the like.

Accordingly, the multilayer ceramic capacitor 1 according to the present embodiment is manufactured.

The dielectric composition according to the present embodiment can exhibit a high relative permittivity. In the main phases 14 having a tungsten bronze structure, it is found that when the main phases 14 have an average particle size of about 1.5 μm or less, the relative permittivity tends to improve as the average particle size of the main phases 14 increases, but when the main phases 14 have an average particle size of more than about 1.5 μm, the relative permittivity tends to decrease as the average particle size of the main phases 14 increases.

There is a correlation between a diffusion coefficient of the atom having the slowest diffusion rate among atoms constituting a compound and a grain growth rate. Here, when the compound is an oxide, “oxygen” is the atom having the slowest diffusion rate. Then, it is found that the addition of an element serving as a donor tends to decrease the diffusion coefficient of oxygen, and that the addition of an element serving as an acceptor tends to increase the diffusion coefficient of oxygen.

For these reasons, it is attempted to select RE as a donor in which a part, particularly the Ba²⁺ site, of the element constituting a tungsten bronze structure is easily replaced, namely, the ionic radius is close to that of Ba²⁺ among elements serving as donors and to diffuse RE with predetermined conditions (“central-portion RE concentration/peripheral-portion RE concentration” is 0.2 or less or “central-portion RE concentration/grain-boundary RE concentration” is 0.18 or less) in a dielectric composition, and it is found that this dielectric composition exhibits a high relative permittivity.

In the present embodiment, the existence of RE in a predetermined distribution in the dielectric composition can reduce the diffusion coefficient of oxygen, and it is considered that the grain growth of the main phases 14 during firing can consequently be prevented. Moreover, in the present embodiment, since the grain growth of the main phases 14 during firing can be prevented, the particle sizes of the main phases 14 can be adjusted within a desired range, and it is considered that a high relative permittivity can consequently be exhibited. Moreover, in the present embodiment, a high strength can also be exhibited.

As described above, since the oxygen diffusion coefficient increases due to the addition of an element as an acceptor, the main phases 14 may grow abnormally, and the relative permittivity may decrease. Thus, in the prior arts, the relative permittivity may decrease due to the addition of Mn or Fe serving as an acceptor.

### Second Embodiment

Except for the following matters, the present embodiment is the same as First Embodiment. A dielectric composition according to the present embodiment includes segregation phases containing Ba and Nb in grain boundaries existing between main phases. Hereinafter, the segregation phases containing Ba and Nb are referred to as “Ba—Nb based segregation phases”.

In the Ba—Nb based segregation phases according to the present embodiment, a Ba content is larger than a Nb content. The composition of the Ba—Nb based segregation phases is, for example, Ba₅Nb₄O₁₅.

In the present embodiment, the method for determining whether or not a dielectric composition constituting dielectric layers includes Ba—Nb based segregation phases is not limited, and for example, there is a method of comparing a mapping image of Ba and a mapping image of Nb. The main phases according to the present embodiment also contain Ba and Nb, but a Nb content is larger than a Ba content in the main phases. Thus, a more intense signal than the surroundings is detected in the mapping image of Ba, but a portion where a weaker signal than the surroundings is detected in the mapping image of Nb can be determined as a Ba—Nb based segregation phase.

The method of manufacturing a multilayer ceramic capacitor according to the present embodiment is not limited. For example, a multilayer ceramic capacitor according to the present embodiment can be obtained by adding an “oxide containing Ba and Nb” in addition to a mixture of a composite oxide constituting the main phases and RE, a binder, and a solvent, kneading them, and turning them into a paint so as to prepare a dielectric layer paste in a step of preparing a paste for manufacturing green chips in First Embodiment and, except for this step, by performing the same steps as in the method of manufacturing a multilayer ceramic capacitor according to First Embodiment.

The above-mentioned embodiments describe a case where the electronic device according to the present invention is a multilayer ceramic capacitor, but the electronic device according to the present invention is not limited to a multilayer ceramic capacitor and may be any electronic device including the above-mentioned dielectric composition.

Hereinabove, embodiments of the present invention are described, but the present invention is not limited to the above-mentioned embodiments and may be modified in various modes within the scope of the present invention.

For example, in First Embodiment, only the calcined powder of the composite oxide constituting the main phases 14 was obtained, but a part of an oxide of RE may also be calcined together with the raw material of the main phases 14. That is, a calcined powder of the composite oxide constituting the main phases 14 and a part of an oxide of RE may be obtained by performing a wet mixing for a part of an oxide of RE together with the raw material of the main phases 14 for a predetermined time using a ball mill or the like, drying this mixed powder, and thereafter performing a heat treatment in the atmosphere at a temperature of 700 to 1300° C.

As described above, however, since the peripheral-portion RE concentration and the grain-boundary RE concentration easily become sufficiently higher than the central-portion RE concentration by uniformly dispersing a pulverized product of RE around the composite oxide constituting the main phases 14, the oxide of RE calcined together with the composite oxide constituting the main phases 14 is preferably just a part of the oxide of RE. Specifically, 0 to 50 mass % of the oxide of RE may be calcined together with the composite oxide constituting the main phases 14.

Moreover, in First Embodiment, a mixture of the composite oxide constituting the main phases 14 and RE is obtained by dispersing the calcined powder of the composite oxide constituting the main phases 14 and the pulverized product of RE under high pressure together with a dispersion medium, uniformly dispersing the pulverized product of RE around the composite oxide constituting the main phases 14, and drying them, but a mixture of the composite oxide constituting the main phases 14 and RE may also be obtained by mixing and drying the calcined powder of the composite oxide constituting the main phases 14 and a dispersion medium in which a compound of RE is dissolved so as to uniformly disperse RE around the composite oxide constituting the main phases 14. The “compound of RE” dissolved in a dispersion medium is, for example, a metal organic compound of RE.

Moreover, when a paste for producing green chips is prepared, a dielectric layer paste may be prepared by kneading a mixture of a calcined powder of a composite oxide constituting the main phases 14 and a pulverized product of RE not dispersed under high pressure, a binder, and a solvent, turning them into a paste, and dispersing them under high pressure. This method also enables RE to be uniformly dispersed around the composite oxide constituting the main phases 14.

Moreover, when a paste for producing green chips is prepared, a dielectric layer paste may be prepared by kneading a mixture of a calcined powder of a composite oxide constituting the main phases 14 and a pulverized product of RE dispersed under high pressure, a binder, and a solvent, turning them into a paste, and dispersing them under high pressure. This method also enables RE to be uniformly dispersed around the composite oxide constituting the main phases 14.

### EXAMPLES

Hereinafter, the present invention is described in more detail with Examples and Comparative Examples. However, the present invention is not limited to Examples below.

### Experiment 1

Powders of barium carbonate (BaCO₃), zirconium oxide (ZrO₂), and niobium oxide (Nb₂O₅) were prepared as starting raw materials for main phases 14 of a dielectric composition. The prepared starting raw materials were weighed so that the molar ratio of BaCO₃, ZrO₂, and Nb₂O₅ would be BaCO₃:ZrO₂:Nb₂O₅=3.1:1.1:2.

Next, each of the weighed powders was mixed in a wet manner by a ball mill for 16 hours using an ion-exchanged water as a dispersion medium, and this mixture was dried to obtain a mixed raw material powder. After that, the obtained mixed raw material powder was subjected to a heat treatment in the atmosphere at a holding temperature of 900° C. for a holding time of 2 hours to obtain a calcined powder of a composite oxide constituting the main phases 14.

An oxide of RE shown in Table 1 was weighed so as to have the amount shown in Table 1 with respect to 4 parts by mol of Nb in the composite oxide constituting the main phases 14. The addition amount of RE shown in Table 1 is the addition amount when the Nb content of the composite oxide constituting the main phases 14 is 4 parts by mol.

The oxide of RE was finely pulverized by a bead mill to obtain a finely pulverized product of the oxide of RE.

The obtained calcined powder of the composite oxide and the finely pulverized product of the oxide of RE were pulverized in a wet manner by a ball mill for 16 hours using an ion-exchanged water as a dispersion medium, further dispersed under high pressure by a high pressure homogenizer, and dried to obtain a dry pulverized product.

100 mass % of the dry pulverized product was added with 10 mass % of an aqueous solution containing 6 mass % of a polyvinyl alcohol resin as a binder and granulated to obtain a granulated powder.

The obtained granulated powder was put into a die of φ12 mm, subjected to a temporary press molding at a pressure of 0.6 ton/cm², and further subjected to a main press molding at a pressure of 1.2 ton/cm 2 to obtain a disk-shaped green compact.

The obtained green compact was fired in the air to obtain a sintered body. As conditions for the firing, the heating rate was 200° C./h, the holding temperature was 1375° C., and the holding time was 2 hours.

Both main surfaces of the obtained sintered body were coated with an In—Ga alloy to form a pair of electrodes. Then, a disk-shaped ceramic capacitor sample was obtained.

### (Average Particle Size of Main Phases)

The obtained sintered body was thinned with a focused ion beam processing apparatus (FIB) to manufacture a sample. The thinned sample was observed with a STEM, and the main phases 14 were determined. The observation field of view at this time was 2 μm×2 μm. Likewise, the main phases 14 were also determined in other two observation fields of view, and the main phases 14 were determined in three observation fields of view in total. An average value of particle sizes (circle area equivalent diameters) of the main phases 14 in the above-mentioned three observation fields of view was determined as an “average particle size of main phases”. Table 1 shows the results. The average particle size was obtained from the main phases 14 whose entire outer circumferences were included in the observation fields of view. That is, areas of the main phases 14 even partially protruding from the observation fields of view were not calculated and were not included for the calculation of the average particle size of the main phases.

### (Central-Portion RE Concentration/Peripheral-Portion RE Concentration and Central-Portion RE Concentration/Grain-Boundary RE Concentration)

In the above-mentioned three observation fields of view, a central-portion RE concentration was measured at three points in each of the observation fields of view and measured at nine points in total, and its average value was calculated.

In the above-mentioned three observation fields of view, a peripheral-portion RE concentration was measured at three points in each of the observation fields of view and measured at nine points in total, and its average value was calculated.

In the above-mentioned three observation fields of view, a grain-boundary RE concentration was measured at three points in each of the observation fields of view and measured at nine points in total, and its average value was calculated.

From the average value of the central-portion RE concentrations, the average value of the peripheral-portion RE concentrations, and the average value of the grain-boundary RE concentrations, “central-portion RE concentration/peripheral-portion RE concentration” and “central-portion RE concentration/grain-boundary RE concentration” were calculated.

### (Presence or Absence of Ba—Nb Based Segregation Phases)

In the above-mentioned three observation fields of view, the presence or absence of Ba—Nb based segregation phases was determined.

### (Relative Permittivity)

For a capacitor sample of the “sintered body fired in the air”, a signal with a frequency of 1 kHz and an input signal level (measurement voltage) of 1 Vrms was applied at a room temperature (20° C.) with a digital LCR meter (4284A manufactured by YHP) to measure a capacitance and a tan S. Then, a relative permittivity (no unit) was calculated based on the thickness of the dielectric layers, the effective electrode area, and the capacitance obtained by the measurement. The relative permittivity is preferably higher. Table 1 shows the results.

(Breakage Probability during Polishing)

First, a metal plate heated by a hot plate was prepared. A paraffin wax was applied to this metal plate, and a sintered body fired in the air was placed thereon and cooled to the room temperature so as to fix the sintered body to the metal plate. While the sintered body was fixed, the metal plate was moved, and a free surface of the sintered body opposite to the surface in contact with the metal plate was entirely polished with a waterproof abrasive paper of #800 and removed. After that, the metal plate to which the sintered body was fixed was immersed into acetone so as to remove the paraffin wax. Among the polished sintered bodies, the number of sintered bodies having cracking was counted by observing the sintered bodies with a stereoscopic microscope. A breakage probability during polishing was calculated by dividing the number of sintered bodies having cracking by the number of polished sintered bodies. It can be determined that the lower the breakage probability during polishing was, the higher the strength was.

### Experiment 2

Experiment 2 relates to Sample No. 21.

In Experiment 2, ceramic capacitor samples were obtained in the same manner as Sample No. 6, except that the entire amount of RE was calcined together with the starting raw material of the main phases 14.

For the obtained sintered bodies or ceramic capacitor samples, an “average particle size of main phases”, “a central-portion RE concentration/a peripheral-portion RE concentration”, “a central-portion RE concentration/a grain-boundary RE concentration”, a “relative permittivity”, and a “breakage probability during polishing” were measured in a similar manner to the above-mentioned one, and the “presence or absence of Ba—Nb based segregation phases” was determined. Table 2 shows the results.

### Experiment 3

Experiment 3 relates to Sample No. 22.

In Experiment 3, ceramic capacitor samples were obtained in the same manner as Sample No. 6, except that half the amount of RE was calcined together with the raw material of the main phases 14, and that the other half amount of RE was turned into a finely pulverized product in the same manner as in Experiment 1, pulverized together with the calcined powder of the composite oxide, dispersed under high pressure, and dried to obtain a dry pulverized product.

For the obtained sintered bodies or ceramic capacitor samples, an “average particle size of main phases”, “a central-portion RE concentration/a peripheral-portion RE concentration”, “a central-portion RE concentration/a grain-boundary RE concentration”, a “relative permittivity”, and a “breakage probability during polishing” were measured in a similar manner to the above-mentioned one, and the “presence or absence of Ba—Nb based segregation phases” was determined. Table 2 shows the results.

### Experiment 4

Experiment 4 relates to Sample Nos. 31 to 34.

In Experiment 4, ceramic capacitor samples were obtained in the same manner as Sample No. 6, except that the addition amount of the additive was changed.

For the obtained sintered bodies or ceramic capacitor samples, an “average particle size of main phases”, “a central-portion RE concentration/a peripheral-portion RE concentration”, “a central-portion RE concentration/a grain-boundary RE concentration”, a “relative permittivity”, and a “breakage probability during polishing” were measured in a similar manner to the above-mentioned one, and the “presence or absence of Ba—Nb based segregation phases” was determined. Table 3 shows the results.

### Experiment 5

Experiment 5 relates to Sample No. 41.

In Experiment 5, ceramic capacitor samples were obtained in the same manner as Sample No. 6, except that a granulated powder was obtained by adding 10 mass % of an aqueous solution containing 2 mass % of a Ba₅Nb₄O₁₅ powder and 6 mass % of a polyvinyl alcohol resin as a binder to 100 mass % of a dry pulverized product.

For the obtained sintered bodies or ceramic capacitor samples, an “average particle size of main phases”, “a central-portion RE concentration/a peripheral-portion RE concentration”, “a central-portion RE concentration/a grain-boundary RE concentration”, a “relative permittivity”, a “breakage probability during polishing”, and a “resistivity” were measured in a similar manner to the above-mentioned one, and the “presence or absence of Ba—Nb based segregation phases” was determined. Table 4 shows the results.

TABLE 1

| | | | | | | | Average | | |
|---|---|---|---|---|---|---|---|---|---|
| | Rare Earth Element | | | Central-Portion RE | | Presence of | Particle | | |
| | | Trivalent | | Concentration/ | Central-Portion RE | Absence of | Size | | Breakage |
| | | Hexacoordinate | Addition | Peripheral- | Concentration/ | Ba—Nb Based | of Main | | Probability |
| Sample | | Ionic Radius | Amount | Portion RE | Grain-Boundary RE | Segregation | Phases | Relative | during |
| No. | Type | [Å] | [mol] | Concentration | Concentration | Phases | [μm] | Permeability | Polishing |
| 1 | none | | | | | none | 3.80 | 248 | 2/10 |
| 2 | La | 1.032 | 0.2 | 0.039 | 0.029 | none | 0.48 | 452 | 0/10 |
| 3 | Ce | 1.010 | 0.2 | 0.039 | 0.027 | none | 0.60 | 536 | 0/10 |
| 4 | Pr | 0.990 | 0.2 | 0.039 | 0.026 | none | 0.44 | 463 | 0/10 |
| 5 | Nd | 0.983 | 0.2 | 0.038 | 0.025 | none | 0.45 | 482 | 0/10 |
| 6 | Sm | 0.958 | 0.2 | 0.038 | 0.025 | none | 0.48 | 587 | 0/10 |
| 7 | Eu | 0.947 | 0.2 | 0.032 | 0.019 | none | 0.58 | 579 | 0/10 |
| 8 | Gd | 0.938 | 0.2 | 0.028 | 0.018 | none | 0.75 | 568 | 0/10 |
| 9 | Tb | 0.923 | 0.2 | 0.027 | 0.016 | none | 0.98 | 550 | 0/10 |
| 10 | Dy | 0.912 | 0.2 | 0.022 | 0.015 | none | 0.91 | 555 | 0/10 |
| 11 | Ho | 0.901 | 0.2 | 0.019 | 0.013 | none | 1.57 | 355 | 2/10 |
| 12 | Er | 0.890 | 0.2 | 0.017 | 0.010 | none | 1.57 | 366 | 2/10 |
| 13 | Tm | 0.880 | 0.2 | 0.015 | 0.011 | none | 1.92 | 347 | 2/10 |
| 14 | Yb | 0.868 | 0.2 | 0.014 | 0.009 | none | 2.16 | 326 | 3/10 |

TABLE 2

| | | | Central-Portion | | | | | |
|---|---|---|---|---|---|---|---|---|
| | | | Rare Earth | Central-Portion | | Average | | |
| | | | Concentration/ | Rare Earth | Presence or | Particle | | |
| | RE | | Peripheral- | Concentration/ | Absence of | Size | | Breakage |
| | | Addition | Portion Rare | Grain-Boundary | Ba—Nb Based | of Main | | Probability |
| Sample | | Amount | Earth | Rare Earth | Segregation | Phases | Relative | during |
| No. | Type | [mol] | Concentration | Concentration | Phases | [μm] | Permeability | Polishing |
| 21 | Sm | 0.2 | 0.870 | 0.641 | none | 1.21 | 392 | 1/10 |
| 22 | Sm | 0.2 | 0.196 | 0.178 | none | 0.60 | 517 | 0/10 |
| 6 | Sm | 0.2 | 0.038 | 0.025 | none | 0.48 | 587 | 0/10 |

TABLE 3

| | | | | | | Average | | |
|---|---|---|---|---|---|---|---|---|
| | | | Central-Portion | | Presence of | Particle | | |
| | RE | | RE Concentration/ | Central-Portion RE | Absence of | Size | | Breakage |
| | | Addition | Peripheral- | Concentration/ | Ba—Nb Based | of Main | | Probability |
| Sample | | Amount | Portion RE | Grain-Boundary RE | Segregation | Phases | Relative | during |
| No. | Type | [mol] | Concentration | Concentration | Phases | [μm] | Permeability | Polishing |
| 31 | Sm | 0.03 | 0.039 | 0.029 | none | 1.32 | 433 | 1/10 |
| 32 | Sm | 0.06 | 0.038 | 0.027 | none | 0.91 | 536 | 0/10 |
| 6 | Sm | 0.2 | 0.038 | 0.025 | none | 0.5 | 587 | 0/10 |
| 33 | Sm | 0.35 | 0.035 | 0.021 | none | 0.42 | 544 | 0/10 |
| 34 | Sm | 0.5 | 0.032 | 0.019 | none | 0.33 | 446 | 0/10 |

TABLE 4

| | | | | | | Average | | |
|---|---|---|---|---|---|---|---|---|
| | | | | | | Particle | | |
| | Rare Earth Element | | Central-Portion | Presence or | Absence of | Size | | Breakage |
| | | Addition | RE Concentration/ | Central-Portion RE | Ba—Nb Based | of Main | | Probability |
| Sample | | Amount | Peripheral- | Concentration/ | Segregation | Phases | Relative | during |
| No. | Type | [mol] | Concentration | RE Concentration | Phases | [μm] | Permeability | Polishing |
| 6 | Sm | 0.2 | 0.038 | 0.025 | none | 0.48 | 587 | 0/10 |
| 41 | Sm | 0.2 | 0.036 | 0.022 | present: | 0.3 | 611 | 0/10 |
| | | | | | Ba₅Nb₃O₁₅ | | | |

Table 1 shows that when the rare earth element was RE (at least one or more selected from La, Ce, Pr, Nd, Sm, Eu, Gd, Tb, and Dy) and “the central-portion RE concentration/the peripheral-portion RE concentration” was 0.2 or less (Sample Nos. 2 to 10), the relative permeability was higher, and the breakage probability during polishing was lower, than those when the rare earth element was Ho, Er, Tm, or Yb and “the central-portion RE concentration/the peripheral-portion RE concentration” was or less (Sample Nos. 11 to 14). The D90 of the particle sizes of the main phases 14 in Sample Nos. 2 to 10 was 3 μm or less.

Table 1 shows that when the rare earth element was RE (at least one or more selected from La, Ce, Pr, Nd, Sm, Eu, Gd, Tb, and Dy) and “the central-portion RE concentration/the grain-boundary RE concentration” was 0.18 or less (Sample Nos. 2 to 10), the relative permeability was higher, and the breakage probability during polishing was lower, than those when the rare earth element was Ho, Er, Tm, or Yb and “the central-portion RE concentration/the peripheral-portion RE concentration” was or less (Sample Nos. 11 to 14).

Table 2 shows that when “the central-portion RE concentration/the peripheral-portion RE concentration” was 0.2 or less (Sample Nos. 22 and 6), the relative permeability was higher, and the breakage probability during polishing was lower, than those when “the central-portion RE concentration/the peripheral-portion RE concentration” was 0.870 (Sample No. 21).

Table 2 shows that when “the central-portion RE concentration/the grain-boundary RE concentration” was 0.18 or less (Sample Nos. 22 and 6), the relative permeability was higher, and the breakage probability during polishing was lower, than those when “the central-portion RE concentration/the peripheral-portion RE concentration” was 0.641 (Sample No. 21).

Table 3 shows that when the RE content of the dielectric composition was 0.05 to 0.4 parts by mol, provided that the D (Nb) content of the dielectric composition was 4 parts by mol (Sample Nos. 32, 6, and 33), the relative permeability was further higher than that when the RE content of the dielectric composition was 0.03 parts by mol (Sample No. 31) or when the RE content of the dielectric composition was 0.5 parts by mol (Sample No. 34).

Table 3 shows that when the RE content of the dielectric composition was 0.05 to 0.4 parts by mol, provided that the D (Nb) content of the dielectric composition was 4 parts by mol (Sample Nos. 32, 6, and 33), the breakage probability during polishing was further lower than that when the RE content of the dielectric composition was 0.03 parts by mol (Sample No. 31).

Table 4 shows that when Ba—Nb based segregation phases were further contained (Sample No. 41), the relative permeability was further higher than that when no Ba—Nb based segregation phases were contained (Sample No. 6).

In Sample No. 41, since Ba₅Nb₄O₁₅ was detected at the time of pulverizing and measuring the obtained dielectric composition by powder X-ray diffraction, the composition of the Ba—Nb based segregation phases is considered to be Ba₅Nb₄O₁₅.

### DESCRIPTION OF THE REFERENCE NUMERICAL

1 . . . multilayer ceramic capacitor
   10 . . . element body
      2 . . . dielectric layer
         14 . . . main phase
         14a . . . central portion
         14b . . . peripheral portion
         16 . . . grain boundary
      3 . . . internal electrode layer
   4 . . . external electrode

What is claimed is:

1. A dielectric composition comprising:
main phases having a tungsten bronze structure; and
grain boundaries existing between the main phases,
wherein
at least one or more rare earth elements selected from La, Ce, Pr, Nd, Sm, Eu, Gd, Tb, and Dy is RE, and
a concentration ratio of RE in central portions of the main phases to RE in peripheral portions of the main phases is 0.2 or less.

2. A dielectric composition comprising:
main phases with a tungsten bronze structure; and
grain boundaries existing between the main phases,
wherein
at least one or more rare earth elements selected from La, Ce, Pr, Nd, Sm, Eu, Gd, Tb, and Dy is RE, and
a concentration ratio of RE in central portions of the main phases to RE in the grain boundaries is 0.18 or less.

3. The dielectric composition according to claim 1, wherein the main phases have an average particle size of 1.5 μm or less.

4. The dielectric composition according to claim 2, wherein the main phases have an average particle size of 1.5 μm or less.

5. The dielectric composition according to claim 1, wherein a composition of the main phases is represented by a formula of AₐB_{b}D₄O₁₅₊α, in which
A includes at least Ba and RE,
B includes at least Zr,
D includes at least Nb,
a is 3.05 or more, and
b is 1.01 or more.

6. The dielectric composition according to claim 2, wherein a composition of the main phases is represented by a formula of AₐB_{b}D₄O₁₅₊α, in which
A includes at least Ba and RE,
B includes at least Zr,
D includes at least Nb,
a is 3.05 or more, and
b is 1.01 or more.

7. The dielectric composition according to claim 5, wherein an RE content of the dielectric composition is 0.05 to 0.4 parts by mol, provided that a D content of the dielectric composition is 4 parts by mol.

8. The dielectric composition according to claim 6, wherein an RE content of the dielectric composition is 0.05 to 0.4 parts by mol, provided that a D content of the dielectric composition is 4 parts by mol.

9. The dielectric composition according to claim 1, further comprising a segregation phase including Ba and Nb.

10. The dielectric composition according to claim 2, further comprising a segregation phase including Ba and Nb.

11. An electronic device comprising the dielectric composition according to claim 1.
